(19) United States
(12) Patent Application Publication
(10) Pub. No.: US 2004/0093256 A1
(43) Pub. Date: May 13, 2004

(54) Automated labor overtime projection method

(76) Inventors: Luis Garcia, Slinger, WI (US); Nathan L. Garvey, Oshkosh, WI (US); Christopher H. Daute, Grafton, WI (US); James A. Hennen, Hartford, WI (US); Bryan D. Dickerson, Hartford, WI (US); Jeffrey H. Peterson, Germantown, WI (US); Jeffrey A. Kuhlow, Fond Du Lac, WI (US)

Correspondence Address: QUARLES & BRADY LLP, 411 E. WISCONSIN AVENUE, SUITE 2040, MILWAUKEE, WI, 53202-4497, US

(21) Appl. No.: 10/291,882

(22) Filed: Nov. 8, 2002

(51) Int. Cl. G06F 17/60

(52) U.S. Cl. 705/9

(57) ABSTRACT

The amount of time actually worked by an employee and the amounts of time that the employee is scheduled to work in the future are analyzed to project whether the employee will be entitled to overtime compensation. That analysis is based on rules which define when overtime compensation accrues. When overtime is projected to occur, a message indicating that projection is automatically sent to supervisory personnel, who can respond by accepting the projected amount of overtime or by changing the employee's work schedule to avoid the overtime occurring.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to computer systems for scheduling employees work hours and for recording the actual amount of time that employees work, and more particularly to a computer system which utilizes scheduled work periods for an employee and actual hours worked to date to project if and when that employee will work overtime in the future.

2. Description of the Related Art

Labor wage and hour laws restrict the number of hours that certain classes of employees may work during given time periods. In other cases, when a defined number of hours have been worked during a specified time period, the employee must receive a higher level of compensation for additional hours worked in that period. Failure to abide by these laws can result in the government assessing stiff penalties against the employer.

In addition, union contracts often require that a covered employee be compensated at different rates depending upon the number of hours worked either within a given wage period, a calendar week or a specified number of consecutive days. Failure to abide by these overtime compensation rules may violate the terms of the contract and result in the assessment of penalties. Many employers also have developed their own rules which provide additional compensation to employees in certain circumstances based on the number of hours worked.

Most large employers utilize a computerized time and attendance system which has replaced the traditional time clocks that imprinted a card with the date and time that an employee started and ended each work period. These computerized systems utilize devices that read data from employees identification badges upon entering and leaving the workplace. This action identifies each employee to the time and attendance system. That identification data is transmitted to a central computer for the workplace, which records the employee identification and the current date and time for subsequent use by a payroll program the determines the amount of wages that each employee receives.

Employers also utilize a computerized scheduling systems which assign workers to different work shifts during a future wage period. The resultant schedule is printed and provided to each employee prior to commencement of that wage period, thus informing the employee when to report to for work and the duration of each work period. In many businesses, an employee's work schedule can vary from day to day and week to week. In a hospital for example, an employee may be assigned to work eight hours during each of five consecutive days, while other employees work three consecutive 12 hour days and then not have to report to work for the next four consecutive days. Other employees may be part-time, in which case they work less than an eight hour day. Some employees are not assigned to a specific department, but float wherever additional employees are needed on a given day and these floating employees work often varying amounts of time according to how much work needs to be done.

During an unanticipated situation, such as an emergency, an employee may be called in to work unscheduled hours. As a consequence, although a particular employee may not be scheduled to work more than 40 hours in a given week, the occurrence of an emergency call-in may result that person working a greater number of hours, thus entitling the employee to overtime compensation.

Traditional time and attendance systems determine whether a particular employee is entitled to overtime compensation based on the hours that they actually work during a given reporting period and based on the overtime rules that apply to that employee. Heretofore unless a person was scheduled to work overtime, a supervisor became aware that overtime compensation would accrue only after an employee already had worked the requisite number of hours. By then it was too late for the supervisor to change an employee's work schedule or take other measures to avoid the accrual of overtime resulting from unscheduled work hours.

### SUMMARY OF THE INVENTION

The present inventors realized that it would be desirable that supervisory personnel be alerted when a given employees actual work time deviated from that scheduled in a manner which would result in overtime compensation accruing in the future. In that case, knowing that unanticipated overtime was projected to occur would afford the supervisor an opportunity to take measures to avoid the overtime. For example, if it becomes apparent on Wednesday that if the remaining work schedule is followed, a given employee will accumulate four hours of overtime on Friday, the employee's schedule for Friday could be shortened by four hours, thereby avoiding overtime compensation. Thus, the present inventors recognize the desirability of integrating the employee's scheduled work hours with the time and attendance information relating to the actual hours worked in order to project when overtime will occur and alert supervisory personnel to that eventuality.

When an employee is likely to work overtime during a pay period can be projected by defining one or more rules that determine when time worked by the employee is considered as overtime. The projection process employs a schedule of assigned periods during which the employee is to work in an upcoming plurality of days. That schedule indicates a scheduled amount of time that the employee is to work during each period. As the employee completes a work period, the actual amount of time that the employee worked is recorded. Then each rule is applied to the actual amount of time worked to date and to the scheduled amount of time for future work periods to project whether the employee will work overtime.

In the preferred embodiment of the overtime projection method, an indication is produced to alert management personnel when overtime is projected to occur. In some versions of the method, such an alert is issued only when a projected amount of overtime is greater than a predefined acceptable limit.

### BRIEF DESCRIPTION OF THE DRAWINGS

FIG. 1 is a schematic diagram of a computer system for scheduling employees work time and recording time and attendance information;

FIG. 2 represents the data structure of a file containing work schedules for employees;

FIG. 3 depicts the data structure of an entry in the time and attendance data file;

FIG. 4 is a flow chart of the method according to the present invention, which projects when an employee will work overtime;

FIG. 5 represents a data structure used to determine when an overtime condition is anticipated to occur; and

FIG. 6 represents a user display produced from data generated by the overtime projection method which alerts supervisory personnel to projected overtime.

### DETAILED DESCRIPTION OF THE INVENTION

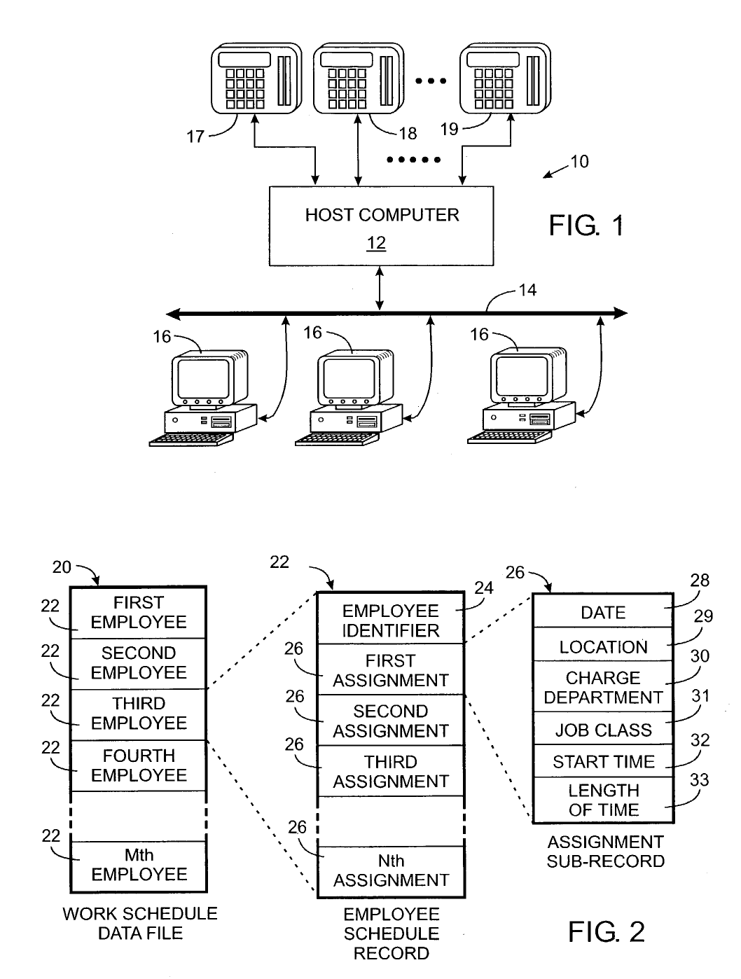

FIG. 1 illustrates a system 10 for scheduling work periods for employees and then recording the actual a time worked by each employee. This system comprises a host computer 12 which executes software programs that perform those functions, and stores the work schedules and the time and attendance data. The host computer is connected to a standard local area network (LAN) 14 of a type commonly found in work places. A plurality of personal computers 16 are connected to the local area network 14 to exchange data and commands with the host computer 12. A plurality of badge readers 17, 18 and 19, through which employees indicate when they start and end periods of work, are located throughout the business and are connected to the host computer 12. The badge readers 17-19 can take any of a number of commercially available forms. For example, each employee identification badge has a magnetic strip that encodes a unique employee number and the magnetic strip is scanned when the employee swipes the identification badge through a slot of a badge reader. Each badge reader 17-19 also has a keypad by which an employee number or other information can be entered into the time and attendance function performed by the computer system 10. A display device of the card readers 17-19 presents information to the employee.

Supervisory personnel use the personal computers 16 to enter employee scheduling information into the host computer 12 and subsequently check and alter the work schedule as necessary. For example, when an employee calls in sick, a supervisor changes the schedule to substitute another employee for the absent worker. Supervisors also utilize the personal computers 16 to monitor attendance and the actual hours worked by the employees. As will be described, such monitoring, identifies when an employee is anticipated to work overtime and allows a supervisor to alter the work schedule to avoid unnecessary or unwanted overtime.

The personal computers 16 enable appropriate personnel to access a standard employee staffing and scheduling program, such as the ActiveStaffer® Series available from Automating Peripherals, Inc. of Hartford, Wisconsin, U.S.A. This software program provides a listing of all the employees available for assignment to a given department and each employee's work preferences, such as a work shift, vacation schedule, and the like. This enables the employees to be assigned to specific work shifts and to an amount of time during each shift, either automatically by the computer program or manually by a supervisor. Some employees may work eight hour shifts, while others have twelve hour shifts. The schedule for each employee is stored in a work schedule data file within a storage device of the host computer 12.

With reference to FIG. 2, the work schedule data file 20 contains a plurality of records 22, each storing the work schedule information for one employee. Employees may be scheduled in advance for one or more weekly periods. For the purpose of describing the present invention, assume that the employees are scheduled in three week periods. Each employee record 22 has a field 24 which contains an identifier of the associated employee. This identifier may be a social security number or a unique employee number assigned by the employer. The remainder of the employee schedule record 22 contains a plurality of work assignment sub-records 26 with the number of such fields varying depending upon how many work periods the employee will work during the three week schedule period. Each work assignment sub-record 26 has a first field 28 which stores the date of the assignment and a second field 29 specifying the location where the employee is to work. In the case of a hospital, for example, a nurse may be assigned to different areas on different days. A third field 30 contains an identification of the department which is to be charged for the employee's time worked on this assignment. A fourth field 31 holds information specifying to the job class associated with this assignment. A given nurse may work as a regular registered nurse (RN) on some days, and as head registered nurse or another capacity on other days. The job class also identifies the wage scale that the employee is to receive for this assignment. The fifth and sixth fields 32 and 33 in the assignment data define the start time of the assignment and its duration. Preferably the duration is specified by the length of the work period (e.g. a number of hours), but alternatively the duration could be indicated by storing the scheduled end time of the work period.

During the scheduling process, data from the work schedule data file 20 is displayed on the screen of the respective personal computer 16 in a spreadsheet format with each lines corresponding to a different employee and columns provided for each work day. In the course of displaying the information, the scheduler software also may acquire data from the main employee file in order to display the that person's job title, seniority, and other information. Although the present invention is being described in the context of use with hospital employees, it should be understood that the inventive concepts can be applied to any type of business or entity with paid employees.

The host computer 12 in FIG. 1 also executes a time and attendance software program, such as the Payrollmation® Series available from Automating Peripherals, Inc. of Hartford, Wis., U.S.A. This type of program records the arrival and departure times of the employees within the hospital. As noted previously, each hourly employee swipes their magnetically encoded employee badge through one of the readers 17-19 upon entering and leaving the work place. This provides an identification of the employee to the host computer 12 which logs that identification along with the date and time of day at which the entry occurred. This implements an electronic time clock which records the arrival and departure of the employees in a time and attendance data file 40 stored within the host computer.

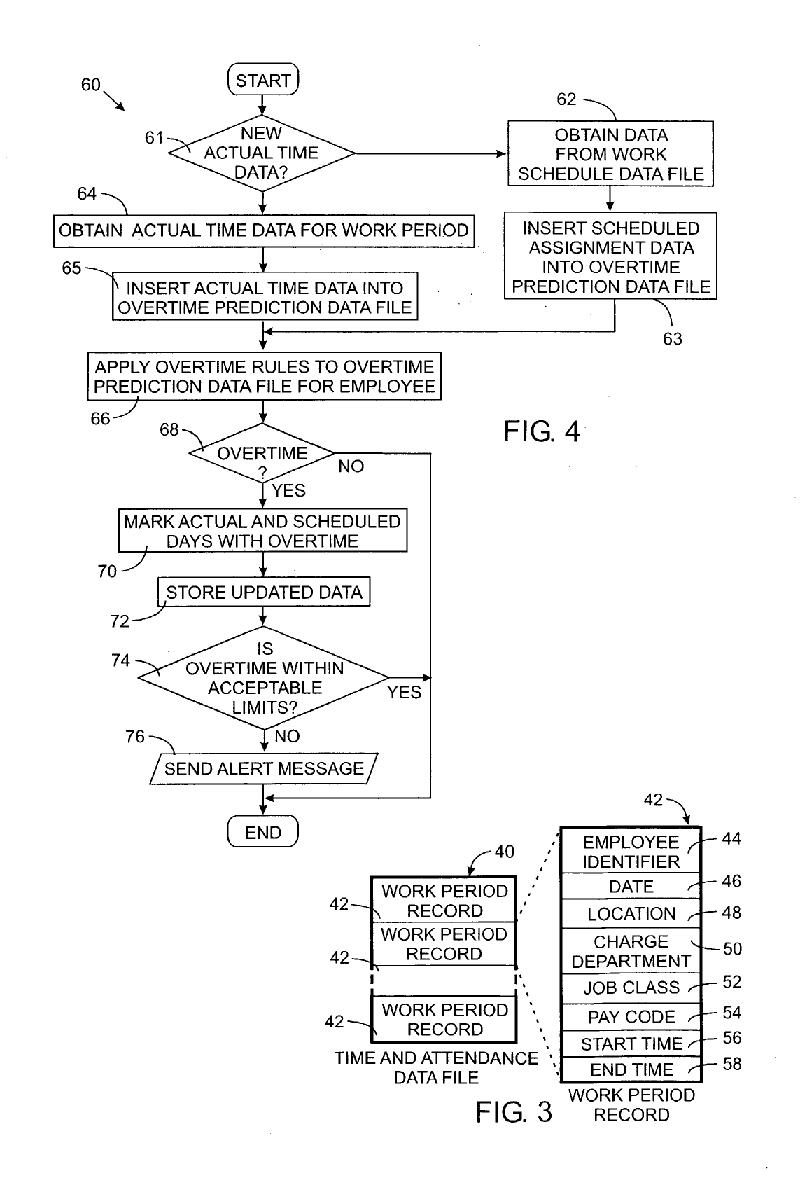

With reference to FIG. 3, the time and attendance data file 40 stores a plurality of records 42 each containing information related to a period actually worked by an employee. Specifically each work period record 42 has a first field 44 that contains the identifier for the associated employee and a second field 46 stores the date on which the work was carried out. Four fields 48, 50, 52, and 54 contain labor distribution information obtained from the corresponding assignment record 26 in the scheduling data file 20. Field 48 identifies the location at which the work was performed, and field 50 specifies the department that is to be charged for this work. Another field 52 provides the job class for this work period, while field 54 stores the pay code that is used to determine the wage for this assignment. In the event that this particular work period relates to an unscheduled assignment, for example an emergency for which the employee was called into work, the labor distribution information in fields 48-54 are created from a manual entries made either by the employee into one of the badge readers 17-19, or by a supervisor via one of the personal computers 16.

When an employee swipes an identification badge through a reader 17-19, the time and attendance software scans the existing records in the time and attendance data file 40 for any open work period records 42 for that employee, i.e. record without data in the end time field 58. If the employee is entering the workplace an open work period record 42 will not be found. In that case, the time and attendance software creates a new work period record 42 for that employee using the employee number read from the identification badge and by gathering data from the corresponding assignment in the work schedule data file 20. The current data and time of day are entered into the corresponding fields of that new record. The work period records 42 are stored chronologically according to the time that an employee arrives at work. Subsequently when a payroll is to be generated the time and attendance data are reorganized into another data file organized by employee number.

The next time the employee swipes the identification badge through a reader 17-19 upon leaving the hospital, the time and attendance program finds the open work created previously when the employee entered the hospital. The current time of day is entered in the end time field 58 of that open record, thereby indicating the end of that word period. The system recognizes when the person clocks into work one day and clocks out of work the next day, because the end time is appears to be earlier than the start time. For example, if the start time is 10:00 p.m. and the end time is 7:00 a.m., the system will recognize that the employee clocked out at 7:00 a.m. the next day and will compute the hours worked accordingly.

After entering an end time into a work period record 42, the time and attendance software calls an overtime projection routine 60, depicted by the flow chart in FIG. 4. The overtime projection routine 60 analyzes the time actually worked and the time scheduled for the future to determine whether this particular employee will work overtime and if so, on which day or days the overtime will occur. In the preferred implementation, an overtime projection routine 60 is executed whenever a change is made to the schedule data file 20 or to the time and attendance data file 40, so that the projections of overtime will be current. Alternatively, the overtime projection routine 60 can be executed at defined times during the day (for example a certain amount of time after the end of each work shift), upon manual activation, or when a supervisor seeks to display the projections.

When the overtime projection routine 60 is first run after creation of a new work schedule data file 20, the newly scheduled work assignments are added to an overtime projection data file 80. When the routine commences, a determination is made at step 61 whether the execution was triggered by entry on new data by an employees clocking out. When a schedule change triggered the overtime projection routine 60 the execution branches to step 62 at which the schedule change or changes are read from the work schedule data file 20 and then inserted into the overtime projection data file 80 at step 63. For example, the overtime projection data file contains data for a three-week period, consisting of the current week and two weeks into the future, however periods of other lengths can be used. Thus the newly scheduled days are added at the end of the overtime projection data file 80. The execution then advances to step 66 to provide indications of overtime which has been scheduled for the employees.

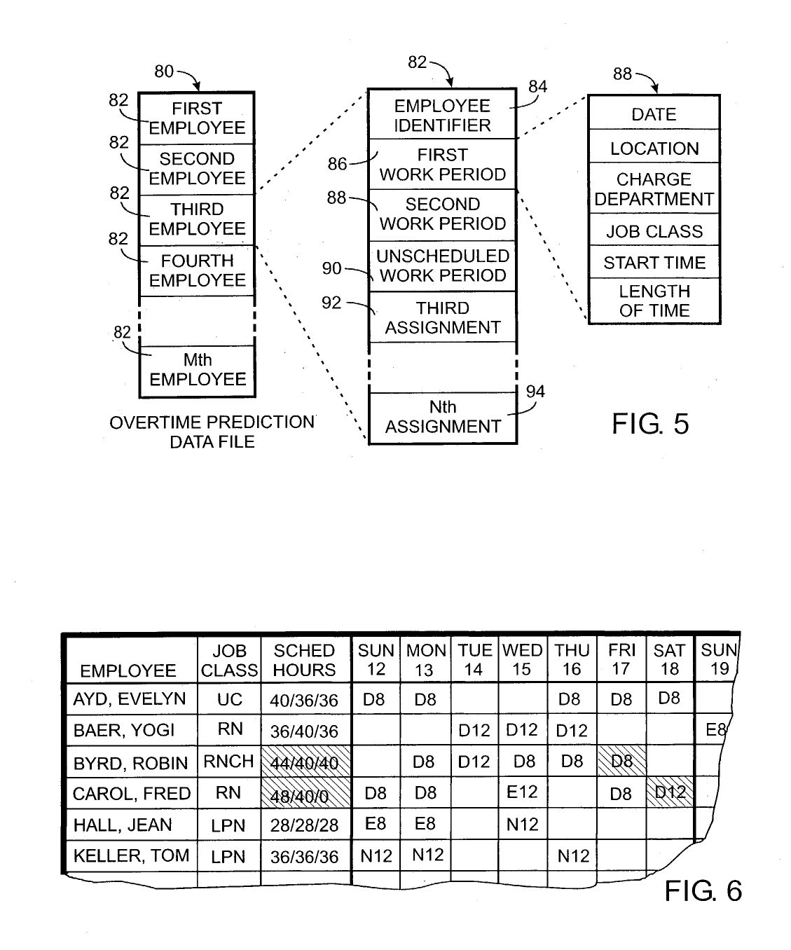

As noted the overtime projection routine 60 also is executed each time an employee clocks out of work. In this case, the execution branches from step 61 to step 64 at which the actual time data for the completed work period record 42 from the time and attendance data file 40 is accessed and copied into the overtime projection data file 80 at step 65 as a work period record depicted in FIG. 5. The actual amount of time worked also is stored in the newly entered record. A record containing actual work period data is be distinguished from a record for scheduled work period, by a data flag or other means.

The overtime projection routine 60 then searches the overtime projection data file 80 for records of scheduled work assignments which should have terminated before the present time of day. This is accomplished by adding the length of time for the scheduled assignment to its start time and, if the resultant time of day has past, that assignment record is deleted from the overtime projection data file 80. Any assignments yet to be completed are left in this data file. As a result, records 86 and 88 in the exemplary overtime projection data file 80 in FIG. 5 correspond to completed scheduled work assignments and record 90 contains data for an unscheduled work period which the employee performed. The third and subsequent work assignments have not yet occurred, and thus remain as assignment records 92-94.

Once the overtime projection data file 80 has been updated, the program execution advances to step 66 where the overtime rules applicable to each employee are applied to the records 82 in the overtime projection data file 80. For example, one of these rules may be whether the employee has worked more than 40 hours in a single calendar week. Other rules may be dictated by a union contract or by voluntary rules adopted by the particular employer. For example, overtime may also apply whenever the employee works more than 40 hours in seven consecutive days, even though that seven day period does not correspond to a calendar week. The overtime rules are stored in a separate file in the host computer 12. In applying these rules to the overtime projection data file 80, the software routine 60 looks not only at the actual hours of completed work, as indicated by the work period data (records 86-90), but also looks ahead in time at the remaining scheduled work assignments (records 92-94). In determining whether overtime will occur, the overtime projection routine 60 assumes that the remaining scheduled work assignments will be preformed.

If at step 68 the overtime projection routine 60 finds that a particular employee will not incur overtime, even if all of the remaining scheduled work assignments are performed, execution of the routine terminates. However, when a likelihood of overtime occurring is found at step 68, the program advances to step 70 where the assignments, which will produce overtime hours, are marked with a flag. The updated overtime projection data file 80 then is stored at step 72.

At step 74, a determination is made whether the amount of projected overtime is within acceptable limits as defined by rules formulated by the employer. Most employers recognize that a certain level of overtime is to be expected because it may not be cost effective to eliminate all overtime. In order to eliminate overtime entirely, additional employees would have to be hired and when the salary and benefit costs for those additional employees are taken into account, it may cost the employer more to have additional employees than to incur a certain amount of overtime. The specific overtime acceptability rules typically vary for different job codes, the department of a company, and other factors. For example, the employer may accept up to four hours of overtime for a particular job code. If the projected overtime is found at step 74 to be within the acceptable limits, the program terminates.

However, if the projected overtime is outside those limits, the program execution advances to step 76 where an alert message is sent to the supervisor for this particular employee. The supervisor information is contained within a general employee file stored within the host computer 12. This information is accessed using the employee identifier in field 84 to look up that employee's data and obtain the supervisor's name or other designation. From that information, an e-mail or other form of message is sent to the supervisor, identifying the employee and the date at which expected overtime is to occur. This e-mail is transmitted via the local area network 14 to the e-mail server for the hospital.

Upon receiving the overtime alert message, the supervisor uses one of the personal computers 16 to access the overtime projection data file 80 via a user interface program which produces a spreadsheet-like display depicted in FIG. 6. Alternatively the overtime projection data file 80 may be viewed as a web page on a Internet site which can be accessed by authorized supervisory personnel. Regardless of the means of access, the resultant display has columns for the employee names, job classes, and the total number of hours scheduled for each employee during the three week scheduling period. Only one week of data is shown in FIG. 6 with additional columns extending to the right for all the days of that three week period. Each row of the table relates to a different employee. Each cell of the display indicates the shift and the number of hours to be or which have been worked by that employee on that day. For example, D8 designated eight hours on the daytime shift. The letter E denotes the evening shift, while the letter N indicates the night shift.

Assume that today is Wednesday the 15^{th} of the month, the display contains actual data for Sunday the 12th through Tuesday the 14^{th} and contains scheduled assignment data for the remaining four days of the week. Note for example that Robin Byrd was scheduled to work 40 hours this week, thus having been scheduled to work eight hours during the daytime shift on Tuesday the 14^{th}. However, the display indicates that this employee worked twelve hours (D12) during that daytime shift. As a result, if this person works the remaining scheduled eight hours shifts on Wednesday, Thursday and Friday, some of the time on Friday will become overtime. This event is highlighted by changing the background color of Robin Byrd's display cell for Friday the 17^{th} to draw the viewer's attention to this cell. In addition, the scheduled hours cell also is highlighted. Note that Fred Carol was scheduled to work 48 hours this week (the 48 in the entry 48/40/0), thus being scheduled for four hours of overtime. This overtime event also is indicated by this employee's highlighted display cell for Saturday the 18^{th}. By placing the cursor on the highlighted display cell and clicking the mouse button, the cell opens up to a window displaying the clock in and out times and the number of hours of regular time and overtime.

Upon viewing the displayed information, a supervisor has the option to take several courses of action. The four hours of unscheduled overtime for Robin Byrd may be accepted and that employee allowed to work the full eight hour shift on Friday the 17^{th}. Alternatively, the schedule for Robin Byrd may be changed so that she only works four hours on that Friday, thus working a total of 40 hours for the week and not incurring any overtime. However, shortening the scheduled shift on Friday for Robin Byrd may require assignment another employee to work those eliminated four hours, thus requiring the supervisor to rearrange other worker's schedule. For example, there may be personnel in other departments which are overstaffed and have under utilized employees who are available to work additional time without incurring overtime compensation. In which case, employees from those departments could be assigned to fill in for the four hours that Robin Byrd will not be working.

If the supervisor elects to change the scheduled shift on Friday for Robin Byrd, the supervisor exits the program which displays the overtime projections and starts the scheduling program. That latter program is used enter the desired changes into the work schedule data file 20. Upon completing those changes, the overtime projection routine 60 is called automatically to revise the overtime projection data file 80, as described previously.

Alternatively, the overtime projection routine 60 can be interfaced to the employee staffing and scheduling program to automatically reschedule the employee who is projected to have overtime. As noted previously, computer programs, such as the ActiveStaffer® Series software, are capable of automatically assigning workers to positions needing to be staffed. This software also employs the overtime rules so that overtime occurrences are minimized and allowed only in specific situations defined by the employer. Therefore, when a given employee is projected to work unscheduled overtime, the overtime projection routine 60 sends a message to the employee staffing and scheduling program identifying the employee and when the overtime is projected to occur. The employee staffing and scheduling program responds to this message by running its scheduling procedure, which reduces the time assigned in the future to the identified employee and fills the vacated work period with another employee who can work without qualifying for overtime compensation. Then, the overtime projection routine 60 is called to revise the overtime projection data file 80.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A computerized method for projecting overtime work by an employee, said method comprising:
defining a rule which specifies when time worked by the employee is considered as overtime;
storing a schedule of assigned periods during which the employee is to work in an upcoming plurality of days, the schedule indicating a scheduled amount of time that the employee is to work during each assigned period;
recording information indicating an actual amount of time that the employee worked during completed work periods; and
at a given point in time, applying the rule to the scheduled amount of time for the assigned periods which terminate in the future and to the actual amount of time to project whether the employee will work overtime in the future.

2. The method as recited in claim 1 further comprising activating an alert mechanism in response to projecting that the employee will work overtime.

3. The method as recited in claim 2 wherein activating the alert mechanism comprises sending an email message.

4. The method as recited in claim 1 further comprising transmitting a message in response to projecting that the employee will work overtime.

5. The method as recited in claim 1 further comprising, in response to projecting that the employee will work overtime, revising the schedule of assigned periods of work to reduce the overtime.

6. The method as recited in claim 1 wherein a given point in time occurs whenever the schedule of assigned periods is changed or whenever information indicating an actual amount of time is recorded.

7. The method as recited in claim 1 wherein a given point in time occurs when the schedule of assigned periods is changed or when an actual amount of time is recorded for the employee.

8. The method as recited in claim 1 further comprising:
defining an acceptable amount of overtime; and
in response to projecting that the employee will work overtime, determining whether that overtime exceeds the acceptable amount of overtime.

9. The method as recited in claim 8 further comprising activating an alert mechanism when the acceptable amount of overtime is exceeded.

10. A method for projecting overtime work by employees, said method comprising:
defining a rule which specifies when time worked by an employee is considered as overtime;
entering information in a computer data storage system which specifies, for each of a plurality of employees, assigned periods of time during which the respective employee is to work in upcoming days, the schedule indicating a scheduled amount of time to be worked during each assigned period;
entering, in the computer data storage system, actual amounts of time that each employee worked during completed work periods;
at a given point in time, applying the rule to the scheduled amount of time for the assigned periods which terminate in the future and to the actual amount of time in each completed work period to project whether any of the plurality of employees will work overtime in the future; and
producing an overtime indication in response to projecting that one of the plurality of employees will work overtime.

11. The method as recited in claim 10 wherein activating the alert mechanism comprises sending a message over a communication network.

12. The method as recited in claim 10 wherein activating the alert mechanism comprises sending an email message.

13. The method as recited in claim 1 further comprising, activating a scheduling routine, in response to the overtime indication, which revises future assigned periods of work to reduce the overtime.

14. The method as recited in claim 10 wherein each particular point in time is when an actual amount of time is recorded for one of the employees.

15. The method as recited in claim 10 wherein each particular point in time is whenever an entry is made into the computer data storage system.

16. The method as recited in claim 10 further comprising:
defining an acceptable amount of overtime; and
in response to projecting that the employee will work overtime, determining whether that overtime exceeds the acceptable amount of overtime.

17. The method as recited in claim 16 further comprising activating an alert mechanism when exceeds the acceptable amount of overtime is exceeded.

18. A method for projecting overtime work by an employee, said method comprising:
defining at least one rule which specifies when time worked by the employee is considered as overtime;
creating a schedule of assigned periods during which the employee is to work in an upcoming plurality of days, each entry for an assigned period containing an identification of the employee, a start time of the respective assigned period, and an indication of a duration of the assigned period;
storing a work period record each time that the employee completes a work period wherein each work period record indicates an actual amount of time that the employee worked during the respective completed work period;
applying each rule to the scheduled amount of time for the assigned periods which terminate in the future and to the actual amount of time for each completed work period to project whether the employee will work overtime in the future; and
producing an overtime indication in response to determining that the employee will work overtime.

19. The method as recited in claim 18 wherein each entry in the schedule for an assigned period further contains a designation of a location at which the employee is to work.

20. The method as recited in claim 18 wherein each entry in the schedule for an assigned period further contains a designation of a job classification.

21. The method as recited in claim 18 wherein each entry in the schedule for an assigned period further designates a department to which the employee's time is to be charged.

22. The method as recited in claim 18 wherein each work period record identifies the employee and designates the start time and the end time of the respective work period.

23. The method as recited in claim 18 wherein each work period record designates a wage rate at which the employee is to be compensated for that work period.

24. The method as recited in claim 18 wherein producing the indication comprises sending a message over a communication network.

25. The method as recited in claim 18 further comprising, activating a scheduling routine, in response to the overtime indication, which revises the schedule of assigned periods of work to reduce the overtime.

26. The method as recited in claim 18 further comprising:
defining an acceptable amount of overtime; and
in response to projecting that the employee will work overtime, determining whether that overtime exceeds the acceptable amount of overtime.

27. The method as recited in claim 26 wherein producing the overtime indication further is in response to the acceptable amount of overtime being exceeded.
